(19) United States
(12) Patent Application Publication
(10) Pub. No.: US 2020/0156509 A1
(43) Pub. Date: May 21, 2020

(54) SLIDE APPARATUS

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventors: Satoshi Yamamoto, Mie (JP); Kazuyoshi Ohara, Mie (JP)

(21) Appl. No.: 16/623,068

(22) PCT Filed: Jun. 5, 2018
(86) PCT No.: PCT/JP2018/021476

§ 371 Date: Dec. 16, 2019

(30) Foreign Application Priority Data
Jun. 21, 2017 (JP) 2017-121196

(51) Int. Cl. B60N 2/07; B60R 16/02

(52) U.S. Cl. CPC B60N 2/0715; B60N 2/0725; B60R 16/0215

(57) ABSTRACT

A slide apparatus 10, includes: a tubular rail 11 in which an insertion groove 12A is formed; a slide insertion portion 23 that is slidably inserted into the insertion groove 12A; a cover 25 that is configured to close the insertion groove 12A; and a cover opening-closing portion 30 that is able to, in accordance with sliding of the slide insertion portion 23 in the insertion groove 12A, change the cover 25 between a closed state in which the insertion groove 12A is closed and an open state in which the insertion groove 12A is open.

### TECHNICAL FIELD

The present specification discloses a technique related to a slide apparatus.

### BACKGROUND

A technique is currently known in which slidable seats, doors, or the like are provided on rails that are fixed into vehicles such as automobiles. In Patent Document 1, wheels are rotatably accommodated in a pair of left and right side portion spaces into which the insides of seat rails are partitioned. Seat leg portions that pivotally support the wheels are arranged in upwardly-open spaces whose upper side is open between the pair of side portion spaces, and the seat leg portions are configured to slide in the upwardly-open spaces.

### PRIOR ART DOCUMENT

### Patent Document

Patent Document 1: JP 2013-049402A

### SUMMARY OF THE INVENTION

### Problems to be Solved

With the configuration in Patent Document 1, the upper portions of the seat rails are provided with upwardly-open spaces for the seat leg portions to slide in. For this reason, there is concern that the sliding of the seat leg portions or the like could be obstructed if foreign bodies enter the rails from the upwardly-open spaces.

The technique described in the present specification has been completed based on circumstances such as those described above, and an object thereof is to keep foreign bodies from entering the rails.

### Means to Solve the Problem

A slide apparatus according to the present specification includes: a tubular rail in which an insertion groove is formed; a slide insertion portion that is slidably inserted into the insertion groove; a cover that is configured to close the insertion groove; and a cover opening-closing portion that is able to, in accordance with sliding of the slide insertion portion in the insertion groove, change the cover between a closed state in which the insertion groove is closed and an open state in which the insertion groove is open.

In configurations in which the rails include insertion grooves, there is concern that foreign bodies may enter the rails from the insertion grooves. With the present configuration, the insertion grooves of the rails are covered by covers, and it is thus possible to keep foreign bodies from entering the rails from the insertion grooves. Here, there is concern that the covers that cover the insertion grooves may obstruct the sliding of the slide insertion portion that is inserted into the insertion groove, but with the configuration described above, a closed state in which the cover closes the insertion groove and an open state in which the insertion groove is open can be changed by the cover opening-closing portion moving in accordance with the sliding of the slide insertion portion in the insertion groove, and thus it is possible to suppress the occurrence of the cover obstructing the sliding of the slide insertion portion.

The following modes are preferable as embodiments of the technique disclosed in the present specification.

The slide insertion portion is fixed to a seat of a vehicle and slides in accordance with sliding of the seat.

If the insertion grooves are formed in the rails to allow the seats of the vehicle to slide, there is concern that malfunctions may occur due to foreign bodies entering the rails from the insertion grooves, but with this configuration it is possible to prevent malfunctions due to foreign bodies entering the rails of vehicles into which such foreign bodies can easily enter.

The cover opening-closing portion is configured to move in accordance with the sliding of the slide insertion portion, to change the cover from the closed state to the open state when the cover opening-closing portion moves toward the cover that is in the closed state, and to change the cover from the open state to the closed state when the cover opening-closing portion moves away from the cover in the open state.

In this way, it is possible to change between the closed state and the open state of the cover in accordance with the movement of the cover opening-closing portion.

The cover in the open state extends at a position that is away from the rail, and the cover opening-closing portion can move between the cover in the open state and the rail.

In this way, it is possible to move the cover opening-closing portion between the cover and the rail by rerouting the path of the cover away from the rail.

The cover opening-closing portion is configured to roll up the cover in accordance with the sliding of the slide insertion portion.

In this way, it is not absolutely necessary to provide a mechanism to reroute the path of the cover, and therefore it is possible to simplify the configuration of the cover opening-closing portion.

A wire harness is routed in the rail, and the wire harness is configured to move in accordance with movement of the cover opening-closing portion.

In this way, it is possible to simplify the routing path of the wire harness. It is also possible to prevent malfunctions in the path of the wire harness due to a foreign body entering therein

### Effect of the Invention

With the technique described in the present specification, it is possible to keep foreign bodies from entering the rails.

### BRIEF DESCRIPTION OF THE DRAWINGS

FIG. 1 is a perspective view showing a slidable seat that includes a slide apparatus of a first embodiment.

FIG. 2 is a perspective view showing the slide apparatus.

FIG. 3 is a perspective view showing the slide apparatus from a different direction than in FIG. 2.

FIG. 4 is a plan view showing the slide apparatus.

FIG. 5 is a side view showing the slide apparatus.

FIG. 6 is a cross-sectional view taken along line A-A in FIG. 4.

FIG. 7 is a cross-sectional view taken along line B-B in FIG. 4.

FIG. 8 is a perspective view showing the slide apparatus of a second embodiment.

FIG. 9 is a perspective view showing the slide apparatus from a different direction than in FIG. 8.

FIG. 10 is a plan view showing the slide apparatus.

FIG. 11 is a side view showing the slide apparatus.

FIG. 12 is a cross-sectional view taken along line C-C in FIG. 10.

FIG. 13 is a cross-sectional view taken along line D-D in FIG. 10.

### DETAILED DESCRIPTION TO EXECUTE THE INVENTION

### First Embodiment

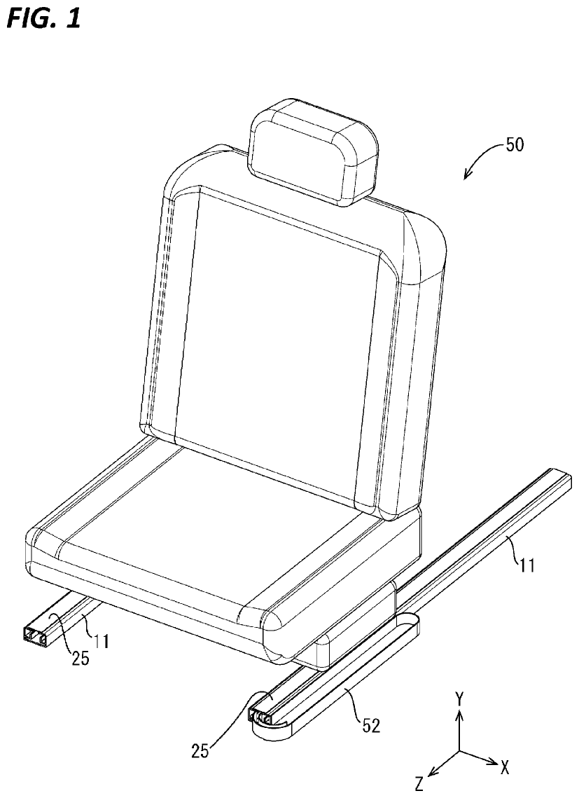

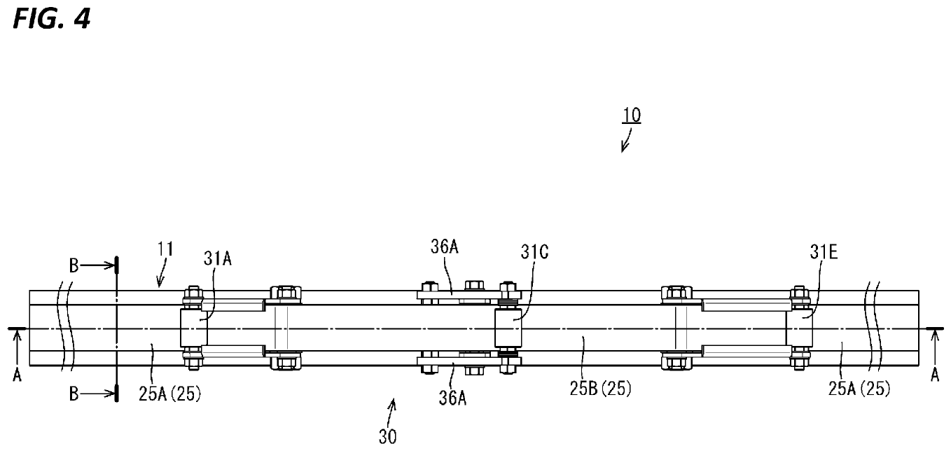

A first embodiment will be described with reference to FIGS. 1 to 7.

A slide apparatus 10 of the present embodiment may, for example, be mounted between a vehicle body of a vehicle, such as an automobile or the like, and a seat 50. The following description will be given with reference to the directions shown in FIG. 1, where the X direction is rightward, the Y direction is upward, and the Z direction is forward.

As shown in FIG. 1, the seat 50 can slide in the front-rear direction on a pair of metal rails 11 that are fixed to the floor of a passenger compartment of a vehicle (not shown). The seat 50 may include various electrical components such as, for example, an electric reclining apparatus, a seat heater, a sensor that detects whether or not a passenger is sitting on the seat, or a sensor that detects whether or not a passenger has fastened their seatbelt.

(Slide Apparatus 10)

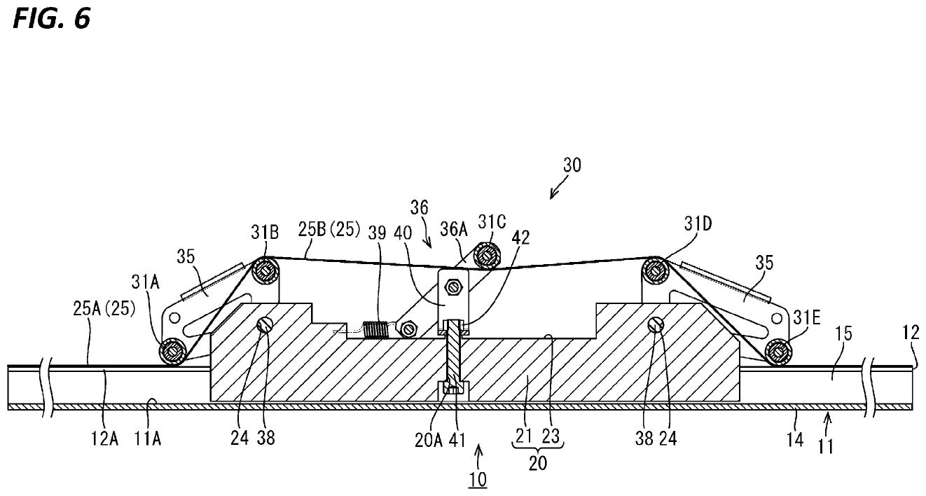

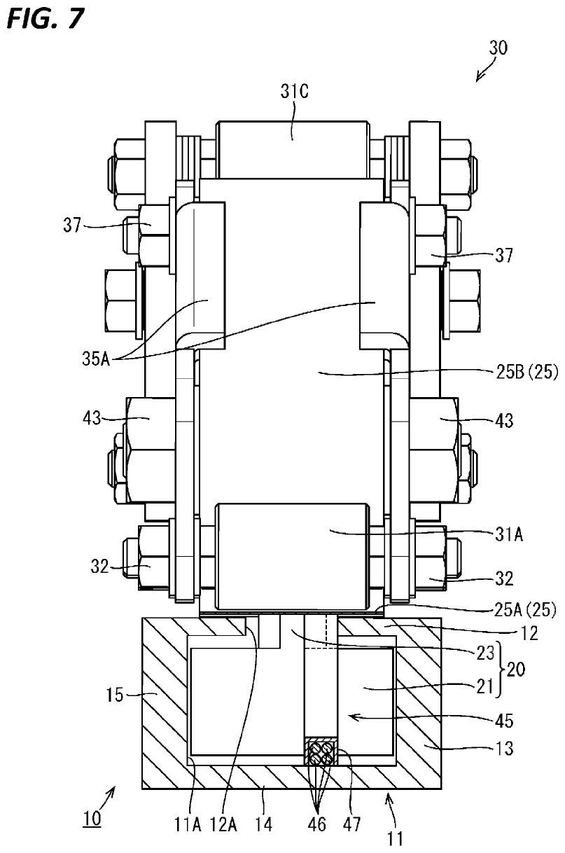

As shown in FIGS. 6 and 7, the slide apparatus 10 includes a pair of rails 11 with insertion grooves 12A formed in upper portions thereof, sliders 20 that include slide insertion portions 23 that are configured to be slidably inserted into the insertion grooves 12A, covers 25 (shown as “cover 25A” when covering the insertion groove 12A in the closed state thereof, and “cover 25B” when not covering the insertion groove 12A in the open state thereof) that cover the insertion grooves 12A, and cover opening-closing portions 30 that change the covers 25 between a closed state and an open state thereof.

(Rails 11)

The rails 11 may be, for example, made of a metal such as aluminum or steel and provided as a pair on the floor under the seat 50. Each rail 11 extends in a belt shape in the front-rear direction and has a rectangular tubular shape including a through hole 11A that passes therethrough in the front-rear direction, and includes a pair of opposed walls 12 and 14 that oppose each other and extend parallel to each other, and a pair of side walls 13 and 15 that are connected to both end portions of the pair of opposed walls 12 and 14. The insertion groove 12A extends in the front-rear direction and passes through the opposed wall 12 on the upper side (the seat 50 side). The insertion groove 12A is provided in the middle portion, with respect to the width direction, of the opposed wall 12, and extends linearly along the entire length of the rail 11.

One of the rails 11 may include, for example, a wire harness 45 that is inserted therein in front of the slider 20, and an excess length absorption member 52 mounted at a position adjacent to the front and the side of said rail 11, as shown in FIG. 1. If the seat 50 slides in the front-rear direction, the excess length of the wire harness 45 that is not accommodated in the rail 11 can be accommodated in the excess length absorption member 52 as the wire harness 45 in the rail 11 moves in the front-rear direction following the seat 50.

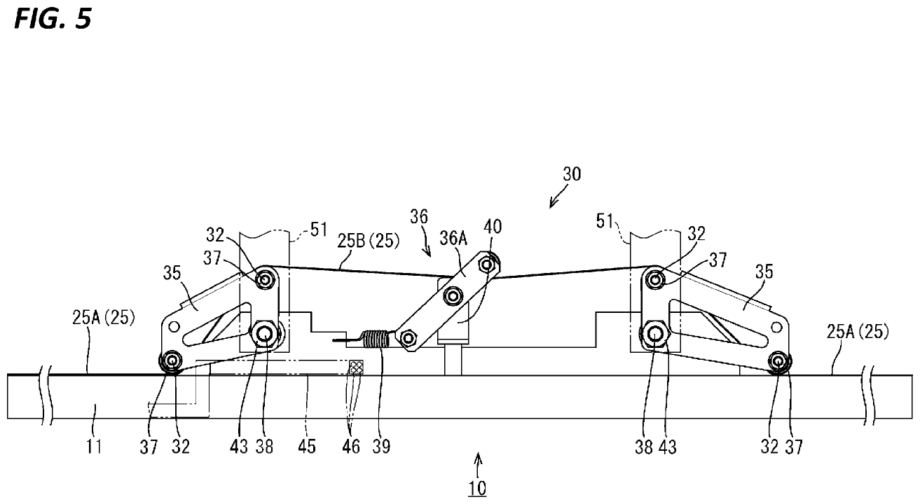

The wire harness 45 is electrically connected to various electrical components of the seat 50 and, as shown in FIG. 7, includes a plurality (four in the present embodiment) of wires 46 that are surrounded by a rectangular tubular exterior cladding 47. The wires 46 may be, for example, covered wires made by convering conductors such as twisted wires made by twisting metallic wires together, or single-core wires or the like with insulating layers. As shown in FIG. 5, one end of the wire harness 45 can be, for example, led out from the top to the side of the insertion groove 12A and connected to an electrical component of the seat 50 through the side of the cover opening-closing portion 30. The other end of the wire harness 45 may, for example, be connected to another device, such as an ECU (Electronic Control Unit) or the like, via a wire harness 45 that is routed over the floor (and under a mat, panel, or the like) or under the floor of the vehicle from an end portion of the wire harness that is accommodated in the excess length absorption member 52.

(Slider 20)

The slider 20 may be made of a synthetic resin or a metal for example, is inserted into the rail 11 and can slide therein, and, as shown in FIG. 7, includes a slider body 21 that is inserted into the rail 11, and the slide insertion portion 23 that protrudes upward from the upper end portion of the slider body 21 and is inserted into the insertion groove 12A. The slider body 21 is fitted into the through hole 11A that passes through the rail 11 in the front-rear direction thereof, and can move in the front-rear direction (the direction in which the rail extends) in the through hole 11A.

The slide insertion portion 23, which has a plank-shape that extends in a direction that intersects with the slider body 21 and the upper surface of the rail 11, is inserted into the insertion groove 12A, and is connected to the cover opening-closing portion 30. The slide insertion portion 23 slides in a slit that is formed in a mat on the floor or the like above the insertion groove 12A. As shown in FIG. 6, connection holes 24 (connection portions) that are connected to the cover opening-closing portion 30 are formed passing through the slide insertion portion 23. A through hole 20A into which a bolt 41 can be inserted is formed in the middle portion, with respect to the front-rear direction, of the slider 20.

(Cover 25)

The cover 25 is a sheet-shaped member that can bend, and may be formed from, for example, a metal such as aluminum or an aluminum alloy or the like, a synthetic resin such as an elastically deformable rubber or the like, or a fabric or the like. The cover 25 extends in a belt-like shape at a length corresponding to the length of the rail 11, and has a predetermined width that is larger than the width of the insertion groove 12A, and smaller than the width of the opposed wall 12. End portions of the cover 25 in the front-rear direction thereof may also be fixed to the upper surface of the rail 11 by a fixing member such as an adhesive, a bolt, or the like.

(Cover Opening-Closing Portion 30)

The cover opening-closing portion 30 is a mechanism that includes five (a plurality of) rollers 31A to 31E that can rotate in a state of pressing against the cover 25, and support members 35 and 36 that rotatably and pivotally support the five rollers 31A to 31E. The cover opening-closing portion 30 moves over the rail 11 in accordance with sliding of the seat 50 and changes between a closed state in which the cover 25 covers the insertion groove 12A and an open state in which the cover 25 is separated from the insertion groove 12A and does not cover the insertion groove 12A.

The plurality of rollers 31A to 31E includes a pair of first rollers 31A and 31E and a pair of second rollers 31B and 31D, all of which are fixed to the support members 35 and regulate the movement direction (path) of the cover 25, and a tension roller 31C that is supported by the support member 36 and regulates the slack of the cover 25B in the open state thereof.

The first rollers 31A and 31E are rotatably and pivotally supported by the front and rear support members 35 respectively, and are arranged such that they are in areal contact with the upper surface (outer surface) of the cover 25, at the position of the border at which the change occurs between the closed state in which the path of the cover 25 covers the insertion groove 12A, and the open state in which the insertion groove 12A is open. The second rollers 31B and 31D are arranged inward from the first rollers 31A and 31E and are in areal contact with the inner surface of the cover 25B at a position that is separated from the upper surface of the rail 11. The portions of the cover 25B that are between the first rollers 31A and 31E and the second rollers 31B and 31D extend in a direction that is inclined with respect to the upper surface of the rail 11. The cover 25B extends between the second roller 31B and the second roller 31D, and is pressed downward (toward the rail 11 side) from the outside thereof by the tension roller 31C.

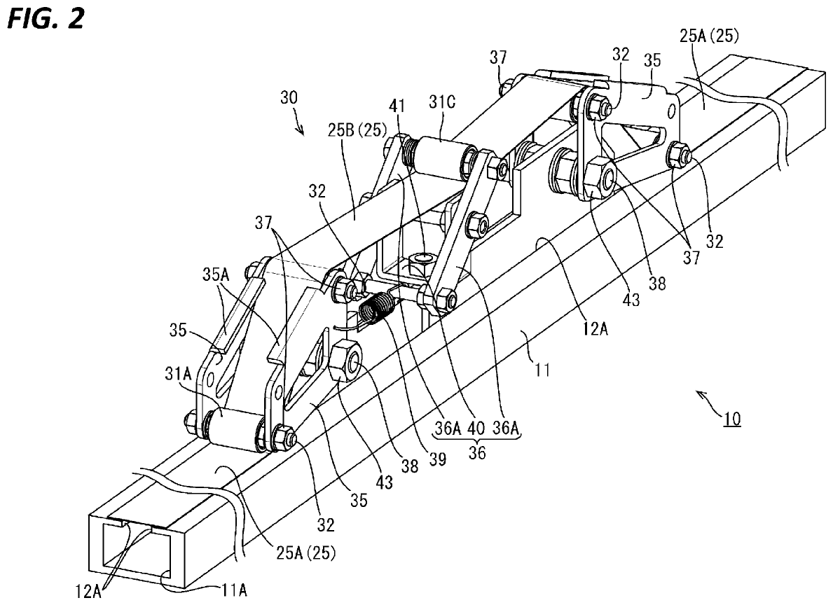

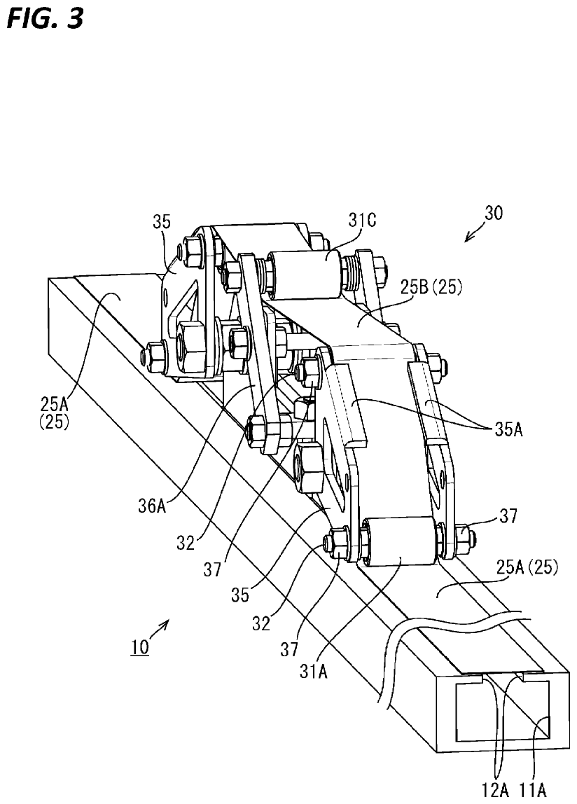

As shown in FIGS. 2 and 3, the support members 35 and 36 include four plank-shaped support members 35 that support the first rollers 31A and 31E and the second rollers 31B and 31D, and the support member 36 that supports the tension roller 31C. The support members 35 each have a quadrangular frame shape and are arranged facing each other, and shaft portions 32 of the first rollers 31A and 31E of the second rollers 31B and 31D are each fastened with a nut 37 as a fastening member at positions in opposing corners of the corner portions of the support members 35, and thus the first rollers 31A and 31E and the second rollers 31B and 31D are rotatably supported. Separation restricting pieces 35A protrude inward from the support members 35 to prevent separation of the cover 25B.

Also, each pair of left and right support members 35 is connected by a rod-shaped portion 38 as a connection member, and the rod-shaped portion 38 is fastened and fixed by nuts 43 as fastening members to the outer surfaces of the support members 35. As shown in FIG. 6, the rod-shaped portions 38 pass through the connection holes 24 of the slide insertion portion 23, and thus fix the support members 35 and the slide insertion portions 23 to each other. As shown in FIG. 5, the rod shaped portions 38 and the support members 35 may also fix the cover opening-closing portion 30 and the seat 50 to each other by, for example, being jointly fastened with the nuts 43 for example to the support members 35 that support extending portions 51 that extend downward from the seat 50.

The support member 36 includes a pair of rod-shaped inclined parts 36A, and a fixing member 40 that is shaped like the letter “U” and rotatably and pivotally supports the inclined parts 36A. One end of each of the inclined parts 36A rotatably and pivotally supports the tension roller 31C, and the other end of each of the inclined parts 36A is fixed to the slide insertion portion 23 by an elastic member 39, which may be a coil spring or the like, for example. The tension roller 31C presses against the cover 25B from the outside thereof due to the elastic force of the elastic member 39. The fixing member 40 is shaped like the letter “U”, and, as shown in FIG. 6, the bottom surface portion thereof is fastened and fixed by the bolt 41, which passes through the through hole 20A in the slider 20, and a nut 42. The inclined parts 36A are rotatably and pivotally supported by a pair of upright pieces that stand upright from the bottom surface portion of the fixing member 40.

With the configuration described above, when the seat 50 is slid forward, the cover opening-closing portions 30 slide forward with the seat 50, the covers 25A in the closed state in front of the cover opening-closing portions 30 change to the open state, and the covers 25B in the open state at the rear end of the cover opening-closing portions 30 change to the closed state. On the other hand, when the seat 50 is slid rearward, the cover opening-closing portions 30 slide rearward with the seat 50, the covers 25A in the closed state behind the cover opening-closing portions 30 change to the open state, and the covers 25B in the open state at the front end of the cover opening-closing portions 30 change to the closed state.

The following actions and effects are attained with the present embodiment.

The slide apparatus 10, includes: the tubular rail 11 in which the insertion groove 12A is formed; the slide insertion portion 23 that is slidably inserted into the insertion groove 12A; the cover 25 that is configured to close the insertion groove 12A; and the cover opening-closing portion 30 that is able to, in accordance with sliding of the slide insertion portion 23 in the insertion groove 12A, change the cover 25 between a closed state in which the insertion groove 12A is closed and an open state in which the insertion groove 12A is open.

In a configuration in which the rails 11 include the insertion grooves 12A, there is concern that a foreign body may enter the rails 11 from the insertion grooves 12A. With the present embodiment, the insertion grooves 12A of the rails 11 are covered by the covers 25, and it is thus possible to keep foreign bodies from entering the rails 11 from the insertion grooves 12A. Here, there is concern that the covers 25 that cover the insertion grooves 12A may obstruct the sliding of the slide insertion portions 23 that are inserted into the insertion grooves 12A. With the present embodiment, the closed state in which the cover 25 covers the insertion groove 12A and the open state in which the insertion groove 12A is open can be changed by the cover opening-closing portion 30 moving in accordance with the sliding of the slide insertion portion 23 in the insertion groove 12A, and it is thus possible to keep the cover 25 from obstructing the sliding of the slide insertion portion 23.

The slide insertion portion 23 is fixed to a seat 50 of a vehicle via the cover opening-and-closing portion 30 and slides in accordance with sliding of the seat 50.

If the insertion grooves 12A are formed in the rails 11 to allow the seat 50 of the vehicle to slide, there is concern that a malfunction may occur due to a foreign body entering the rails from the insertion grooves 12A, but with this embodiment it is possible to prevent malfunctions due to foreign bodies entering the rails 11 of vehicles into which such foreign bodies can easily enter.

The cover opening-closing portion 30 is configured to move in accordance with the sliding of the slide insertion portion 23, to change the cover 25 from the closed state to the open state when the cover opening-closing portion 30 moves toward the cover 25 that is in the closed state, and to change the cover 25 from the open state to the closed state when the cover opening-closing portion 30 moves away from the cover 25 in the open state.

In this way, it is possible to change between the closed state and the open state of the cover 25 in accordance with the movement of the cover opening-closing portion 30, and therefore it is possible to simplify the configuration thereof in comparison to providing a configuration to detect movement of the cover opening-closing portion 30.

The cover 25B in the open state is moved away from the rail 11, and the cover opening-closing portion 30 can move between the cover 25B in the open state and the rail 11.

In this way, it is possible to move the cover opening-closing portion 30 between the cover 25 and the rail 11 by rerouting the path of the cover 25 away from the rail 11.

The wire harness 45 is routed in the rail 11, and the wire harness 45 is configured to move accordance with movement of the cover opening-closing portion 30.

In this way, it is possible to simplify the routing path of the wire harness 45. It is also possible to prevent malfunctioning in the path of the wire harness 45 due to a foreign body entering therein.

### Second Embodiment

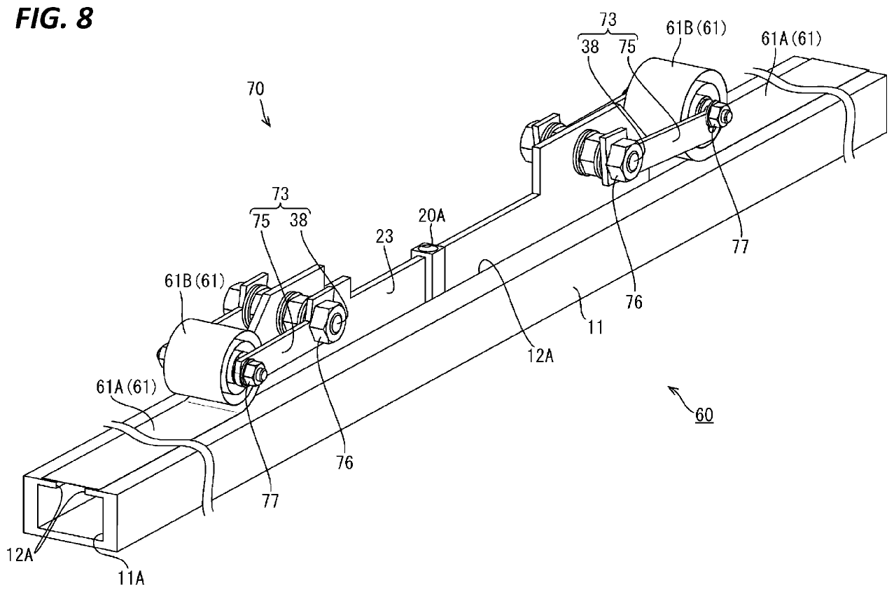

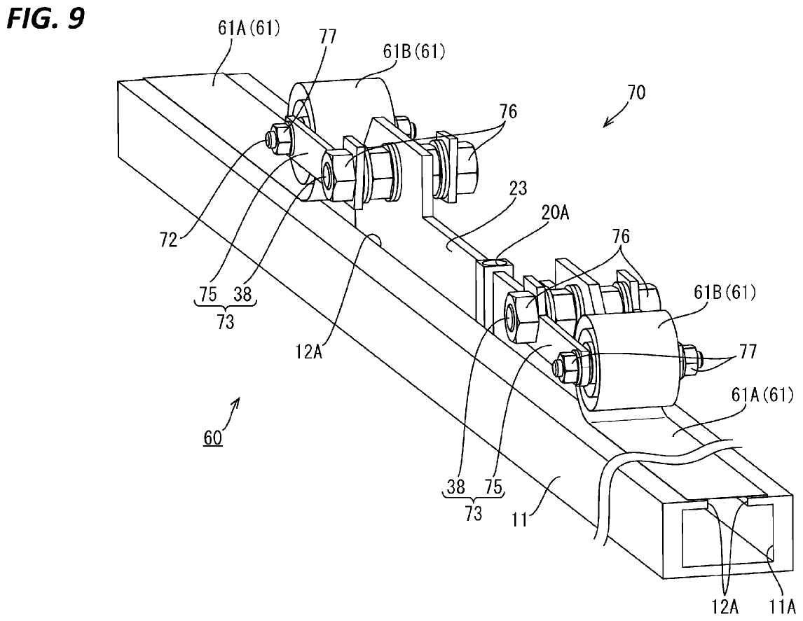

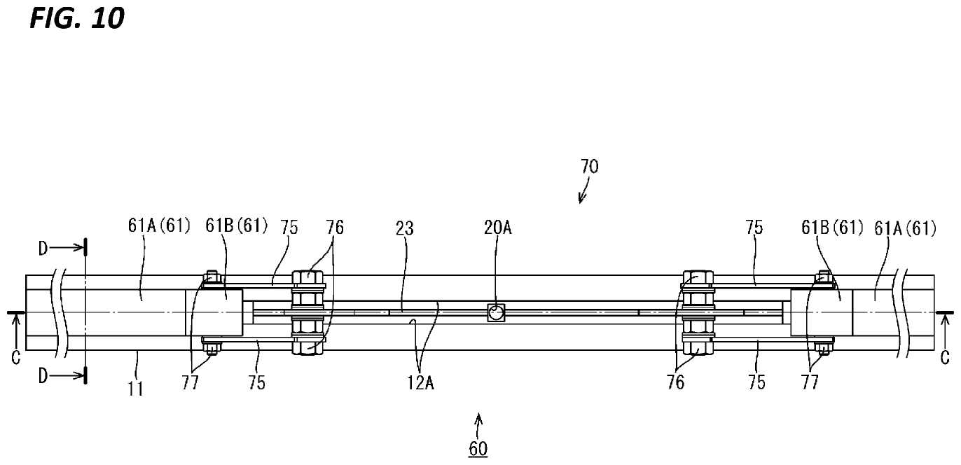

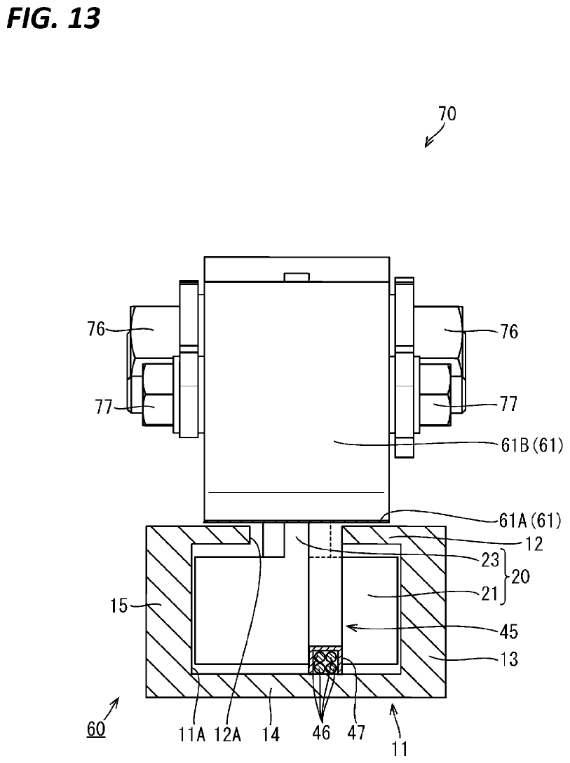

A second embodiment will be described with reference to FIGS. 8 to 13. A cover opening-closing portion 70 of a slide apparatus 60 in the second embodiment includes front and rear rollers 71A and 71B that roll up a cover 61. Other structures are the same as those in the first embodiment, and therefore the same reference numerals will be assigned to the same structures as in the first embodiment, and descriptions thereof shall be omitted in the following description.

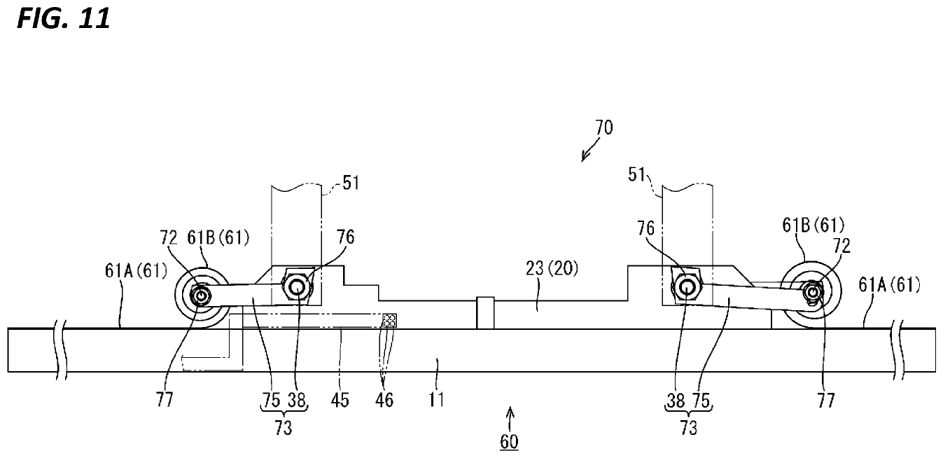

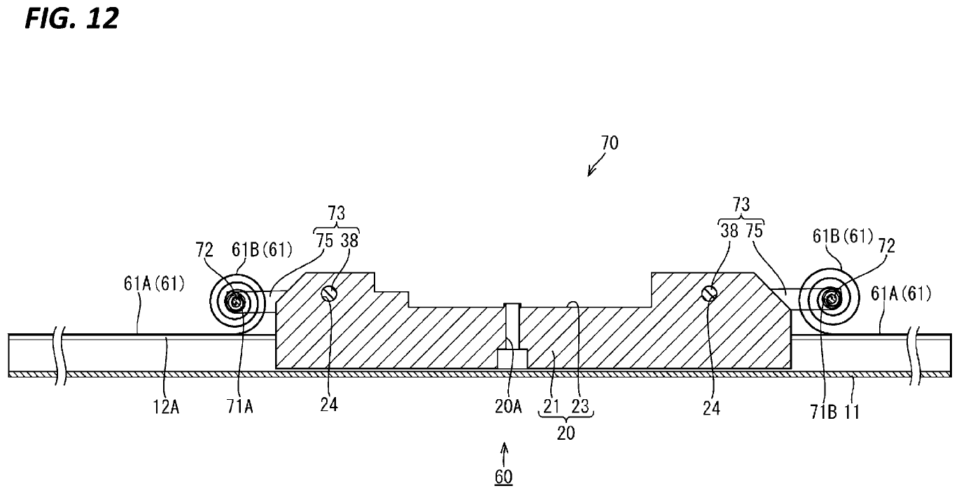

As shown in FIGS. 11 and 12, the slide apparatus 60 includes the rail 11, the slider 20, the cover 61 (shown as “cover 61A” when covering the insertion groove 12A in the closed state, and “cover 61B” when not covering the insertion groove 12A in the open state) that covers the insertion groove 12A, and the cover opening-closing portion 70 that changes the cover 61 between a closed state and an open state.

The cover opening-closing portion 70 includes the rollers 71A and 71B that roll up the cover 61, and fixing portions 73 that rotatably fix the rollers 71A and 71B to the slide insertion portion 23. The fixing portions 73 include rod-shaped portions 38 that pass through the connection holes 24 of the slide insertion portion 23, and connection members 75 that connect the rod-shaped portions 38 and shaft portions 72 of the rollers 71A and 71B. The connection members 75 are fastened and fixed to the rod-shaped portions 38 and the shaft portions 72 by nuts 76 and 77 as the fastening means thereof.

If the cover opening-closing portion 70 moves in accordance with the movement of the seat 50 in a direction that approaches the cover 61A in the closed state, then the rollers 71A and 71B bias toward the cover 61 and rotate, thus rolling up the cover 61. On the other hand, if the cover opening-closing portion 70 moves in a direction away from the cover 61A in the closed state thereof, the rollers 71A and 71B are biased towards the cover 61B, which is in the open state, and rotates, thus unrolling the cover 61 to the insertion groove 12A and putting the cover 61 into the closed state.

According to second embodiment, the cover opening-closing portion 70 is configured to roll up the cover 61 in accordance with the sliding of the slide insertion portion 23.

In this way, it is not absolutely necessary to provide a mechanism to reroute the path of the cover 61, and therefore it is possible to simplify the configuration of the cover opening-closing portion 70.

### OTHER EMBODIMENTS

The technique disclosed in the present specification is not limited to the above embodiments described with reference to the drawings, and, for example, the following embodiments are also included within the technical scope of the technique disclosed in the present specification.

(1) With the embodiments described above, the cover opening-closing portions 30 and 70 are configured to slide, but there is no limitation thereto. For example, a configuration is also possible in which a sensor is provided for detecting the position of the seat 50, the slide insertion portion 23, and the like, and the cover is changed between the closed state and the open state (without the cover opening-closing portion sliding) through the electrical driving force of the cover opening-closing portion.

(2) The slide insertion portion is configured to be fixed to a slidable seat, but there is no limitation thereto. For example, a configuration is also possible in which the slide insertion portion is fixed to a slidable door.

(3) The number of wires that constitute the wire harness is not limited to the number of wires described in the foregoing embodiments, and can be changed to various different numbers.

(4) The embodiments described a configuration in which one of the rails 11 has the wire harness 45 routed therein and the other rail 11 does not have the wire harness 45 routed therein, but there is no limitation thereto, and a configuration is also possible in which in one or both of the rails 11 have the wire harness 45 routed therein, or one or neither of the rails 11 have the wire harness 45 routed therein.

(5) The rails 11 are described as having a rectangular tubular shape, but there is no limitation thereto. The rails 11 may also have a quadrangular shape other than a rectangle, or a tubular shape with multiple corners other than a quadrangular shape.

### LIST OF REFERENCE NUMERALS

10, 60: Slide apparatus
11: Rail
11A: Through hole
12A: Insertion groove
20: Slider
23: Slide insertion portion
25 (25A, 25B), 61 (61A, 61B): Cover
30, 70: Cover opening-closing portion
31A to 31E, 71A, 71B: Roller
35, 36: Support member
45: Wire harness
50: Seat

1. A slide apparatus, comprising:
a tubular rail in which an insertion groove is formed;
a slide insertion portion that is slidably inserted into the insertion groove, is fixed to a seat of a vehicle, and slides in accordance with the sliding of the seat;
a cover that is configured to close the insertion groove; and
a cover opening-closing portion that is able to, in accordance with sliding of the slide insertion portion in the insertion groove, change the cover between a closed state in which the insertion groove is closed and an open state in which the insertion groove is open, wherein
a wire harness is routed in the rail,
the wire harness is led out from the top to the side of the insertion groove, and is connected to an electrical component of the seat through the side of the cover opening-closing portion, and
the wire harness is configured to move in accordance with movement of the cover opening-closing portion.

2. (canceled)

3. The slide apparatus according to claim 1, wherein the cover opening-closing portion is configured to move in accordance with the sliding of the slide insertion portion, to change the cover from the closed state to the open state when the cover opening-closing portion moves toward the cover that is in the closed state, and to change the cover from the open state to the closed state when the cover opening-closing portion moves away from the cover in the open state.

4. The slide apparatus according to claim 1, wherein the cover in the open state extends at a position that is away from the rail, and the cover opening-closing portion can move between the cover in the open state and the rail.

5. The slide apparatus according to claim 1, wherein the cover opening-closing portion is configured to roll up the cover in accordance with the sliding of the slide insertion portion.

6. (canceled)
